(19) United States
(12) Patent Application Publication
(10) Pub. No.: US 2024/0162493 A1
(43) Pub. Date: May 16, 2024

(54) Electrolyte Solution for Lithium Secondary Battery and Lithium Secondary Battery Comprising the Same

(71) Applicants: Hyundai Motor Company, Seoul (KR); Kia Corporation, Seoul (KR); Ulsan National Institute of Science and Technology, Ulsan (KR)

(72) Inventors: Ko Eun Kim, Cheongju-Si (KR); Hui Beom Nam, Hwaseong-Si (KR); Sung Ho Ban, Hwaseong-Si (KR); Yoon Sung Lee, Suwon-Si (KR); Seung Min Oh, Incheon (KR); Jun Ki Rhee, Suwon-Si (KR); Dong Uk Kim, Ulsan (KR); Seung Min Lee, Ulsan (KR); Hyeong Jun Kim, Ulsan (KR); Sung You Hong, Ulsan (KR); Seo Young Jeong, Ulsan (KR); Sang Kyu Kwak, Ulsan (KR)

(21) Appl. No.: 18/383,832

(22) Filed: Oct. 25, 2023

(30) Foreign Application Priority Data
Nov. 1, 2022 (KR) 10-2022-0143831

(51) Int. Cl. H01M 10/0567; H01M 10/052

(52) U.S. Cl. CPC H01M 10/0567; H01M 10/052

(57) ABSTRACT

The present disclosure relates to an electrolyte solution for a lithium secondary battery capable of improving the output and lifespan characteristics at high temperature of a lithium secondary battery, and a lithium secondary battery including the same. An electrolyte solution for a lithium secondary battery includes a lithium salt, a solvent, and a functional additive, wherein the functional additive includes a first electrode film additive, which is 3-(4-cyano-5-(4-nitrophenyl)-1H-1,2,3-triazol-1-yl)propyl 4-methylbenzenesulfonate.

### CROSS REFERENCE TO RELATED APPLICATION

The present application claims priority to Korean Patent Application No. 10-2022-0143831, filed Nov. 1, 2022, the entire contents of which is incorporated herein for all purposes by this reference.

### BACKGROUND

### 1. Field

The present disclosure relates to an electrolyte solution for a lithium secondary battery and a lithium secondary battery including the same, and more particularly, to an electrolyte solution for a lithium secondary battery capable of improving the output and lifespan characteristics at high temperature of a lithium secondary battery, and a lithium secondary battery including the same.

### 2. Discussion of the Background

A lithium secondary battery is an energy storage system composed of a positive electrode providing lithium and a negative electrode receiving the lithium during charging, an electrolyte serving as a lithium ion transfer medium, and a separator separating the positive electrode and the negative electrode from each other. The lithium secondary battery generates and stores an electric energy through a change of chemical potentials when intercalation/deintercalation of lithium ions is performed at the negative and positive electrodes.

The lithium secondary battery has mainly been used in a portable electronic device, but recently, with the commercialization of an electric vehicle (EV) and a hybrid electric vehicle (HEV), the lithium secondary battery has also been used as an energy storage of the electric vehicle and the hybrid electric vehicle.

In particular, recently, as a next-generation energy source for green energy growth, the demand for secondary batteries is increasing.

The lithium secondary battery is composed of four core materials, a positive electrode, a negative electrode, a separator, and an electrolyte, and the performance of the lithium secondary battery is greatly affected by the characteristics of these core materials.

In order to increase a driving distance of the electric vehicle, researches to increase an energy density of the lithium secondary battery have been made, and the energy density of the lithium secondary battery can be increased through high capacity of the positive electrode.

The high capacity of the positive electrode may be achieved through Ni-rich that is a method for increasing Ni contents of Ni—Co—Mn based oxide forming a positive-electrode active material, or may be achieved through voltage heightening of a positive-electrode charging voltage.

However, since the Ni—Co—Mn based oxide in the Ni-rich state has a high interfacial reactivity and an unstable crystal structure, deterioration during cycle is accelerated, and thus it is difficult to secure a long-lifespan performance.

More specifically, in the case of the positive electrode made of Ni—Co—Mn-based oxide in the Ni-rich state, due to the high Ni content and the high reactivity of Ni⁴⁺ formed during charging in the electrolyte solution, there was a problem that reduced the safety and lifespan of the battery, such as the oxidative decomposition of electrolyte solution, the interface reaction of positive electrode-electrolyte solution, metal elution, gas generation, phase change to inert cubic, increased possibility of metal deposition on a negative electrode, increased interfacial resistance of battery, accelerated deterioration, deterioration of charge/discharge performance, and increased instability at high temperature.

Researches on silicon-graphite based negative-electrode active materials containing silicon have been continuously conducted to increase the capacity of the negative electrode in line with the increase in the capacity of the positive electrode. But there was still a problem in that the lifespan was reduced due to the volume change in silicon and interfacial instability.

More specifically, in the case of the silicon-graphite based negative-electrode, there was a problem that the lattice volume increased by more than 300% during charging and the volume decreased during discharging. Also, there was a problem that reduced the safety and lifespan of the battery, such as the formation of large amounts of Si surface inactive chemical species due to the interfacial reaction with LiPF₆ salt, low SEI coverage, weak mechanical strength, increased interfacial resistance, performance degradation, gas generation, and electrolyte consumption.

The description given in this section is only to understand the background of the present disclosure, but should not be recognized as a prior art already known to a person skilled in the art.

### SUMMARY

The present disclosure provides an electrolyte solution for a lithium secondary battery capable of improving the output and lifespan characteristics of a lithium secondary battery at high temperature, and a lithium secondary battery including the same.

The technical objects that can be achieved through the present disclosure are not limited to what has been particularly described hereinabove and other technical objects not described herein will be more clearly understood by persons skilled in the art from the following detailed description.

An electrolyte solution for a lithium secondary battery according to an embodiment of the present disclosure includes a lithium salt, a solvent, and a functional additive, wherein the functional additive includes a first electrode film additive, which is 3-(4-cyano-5-(4-nitrophenyl)-1H-1,2,3-triazol-1-yl)propyl 4-methylbenzenesulfonate, represented by the following Formula 1.

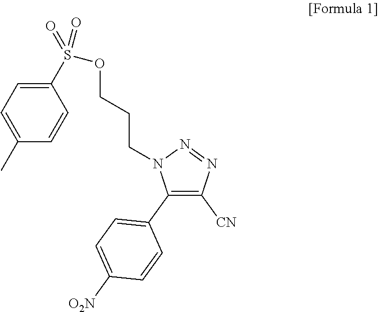 [SMILES: Cc1ccc(S(=O)(=O)OCCCn2nnc(C#N)c2-c2ccc([N+](=O)[O-])cc2)cc1]

The first electrode film additive is in an amount of 0.01 to 1.0% by weight based on a weight of the electrolyte solution.

Preferably, the first electrode film additive is in an amount of 0.05 to 0.1% by weight based on the weight of the electrolyte solution.

The functional additive further includes a negative-electrode film additive which is vinylene carbonate (VC).

Preferably, the negative-electrode film additive is added in an amount of 0.5 to 2.0% by weight based on a weight of the electrolyte solution.

The functional additive further includes a second electrode film additive which is lithium difluorophosphate (LiPO₂F₂).

Preferably, the second electrode film additive is added in an amount of 0.5 to 2.0% by weight based on a weight of the electrolyte solution.

The lithium salt includes one or a mixture of two or more selected from the group consisting of LiPF₆, LiBF₄, LiClO₄, LiCl, LiBr, LiI, LiBioCl₁₀, LiCF₃SO₃, LiCF₃CO₂, LiAsF₆, LiSbF₆, LiAlCl₄, CH₃SO₃Li, CF₃SO₃Li, LiN(SO₂C₂F₅)₂, Li(CF₃SO₂)₂N, LiC₄F₉SO₃, LiB(C₆H₅)₄, LiB(C₂O₄)₂, LiPO₂F₂, Li(SO₂F)₂N, LiFSI, and (CF₃SO₂)₂NLi.

The solvent includes one or a mixture of two or more selected from the group consisting of a carbonate-based solvent, an ester-based solvent, an ether-based solvent, and a ketone-based solvent.

Meanwhile, a lithium secondary battery according to an embodiment of the present disclosure includes the above-described electrolyte solution.

In addition, the lithium secondary battery further includes a positive electrode including a positive-electrode active material containing Ni, Co, and Mn; a negative electrode including a negative-electrode active material containing one or more selected from a carbon (C)-based material or a silicon (Si)-based material; and a separator interposed between the positive electrode and the negative electrode.

The positive electrode includes a Ni content of 60% by weight or more.

The negative-electrode active material is graphite.

The lithium secondary battery has a capacity retention rate of 89% or more after 100 cycles of charging and discharging by performing one cycle of charging and discharging under a condition of 2.5 to 4.2V @ 1 C, 45° C.

The lithium secondary battery has a capacity retention rate of 80% or more after 200 cycles of charging and discharging by performing one cycle of charging and discharging under a condition of 2.5 to 4.2V @ 1 C, 45° C.

According to an embodiment of the present disclosure, by the electrolyte material, a C═O-based organic film is formed on the surface of the positive electrode and a LiF-based SEI is formed on the surface of the negative electrode, so that Cell performance can be improved.

In addition, it can be expected that the insertion and deintercalation process of lithium ion can be smoothly performed by the LiF-based SEI formed on the surface of the negative electrode, thereby improving the output characteristics of a battery.

### BRIEF DESCRIPTION OF THE DRAWINGS

FIG. 1 is a view showing a working mechanism of a first electrode film additive according to an example of the present disclosure.

FIG. 2 is a graph showing results of experiments for evaluating the lifespan at high temperature for each composition of an electrolyte solution according to Examples and Comparative Examples.

FIG. 3 is a graph showing results of experiments for evaluating output characteristics at room temperature for each composition of an electrolyte solution according to Examples and Comparative Examples.

### DETAILED DESCRIPTION

Hereinafter, various examples disclosed in the present specification will be described in detail with reference to the accompanying drawings, and the same or similar elements are denoted by the same reference numerals even though they are depicted in different drawings and redundant descriptions thereof will be omitted.

In the following description of the present specification, a detailed description of known functions and configurations incorporated herein may be omitted when it may make the subject matter of the disclosure rather unclear. In addition, the accompanying drawings are provided only for a better understanding of the aspects of the present specification and are not intended to limit technical ideas disclosed in the present specification. Therefore, it should be understood that the accompanying drawings include all modifications, equivalents and substitutions within the scope and sprit of the present disclosure.

It will be understood that although the terms first, second, etc., may be used herein to describe various components, these components should not be limited by these terms. These terms are only used to distinguish one component from another component.

The singular form is intended to include the plural forms as well, unless context clearly indicates otherwise.

In the present application, it will be further understood that the terms “comprises,” “includes,” etc. specify the presence of stated features, integers, steps, operations, elements, components, or combinations thereof, but do not preclude the presence or addition of one or more other features, integers, steps, operations, elements, components, or combinations thereof.

An electrolyte solution for a lithium secondary battery according to the present disclosure may be a material forming an electrolyte applicable to a lithium secondary battery and include a lithium salt, a solvent, and a functional additive.

The lithium salt may be one or a mixture of two or more selected from the group consisting of LiPF₆, LiBF₄, LiClO₄, LiCl, LiBr, LiI, LiBioCl₁₀, LiCF₃SO₃, LiCF₃CO₂, LiAsF₆, LiSbF₆, LiAlCl₄, CH₃SO₃Li, CF₃SO₃Li, LiN(SO₂C₂F₅)₂, Li(CF₃SO₂)₂N, LiC₄F₉SO₃, LiB(C₆H₅)₄, LiB(C₂O₄)₂, LiPO₂F₂, Li(SO₂F)₂N, LiFSI, and (CF₃SO₂)₂NLi.

In this case, the lithium salt may be present at a concentration of 0.1 to 3.0 moles (e.g., 0.1 to 1.2 moles) in the electrolyte solution.

Also, the solvent may be one or a mixture of two or more selected from the group consisting of a carbonate-based solvent, an ester-based solvent, an ether-based solvent, and a ketone based solvent.

In this case, the carbonate-based solvent may be dimethyl carbonate (DMC), diethyl carbonate (DEC), dipropyl carbonate (DPC), methyl propyl carbonate (MPC), ethyl propyl carbonate (EPC), ethyl methyl carbonate (EMC), ethylene carbonate (EC), propylene carbonate (PC), butylene carbonate (BC), fluoroethylene carbonate (FEC), vinylene carbonate (VC), or the like. The ester-based solvent may be γ-butyrolactone (GBL), n-methyl acetate, n-ethyl acetate, n-propyl acetate, or the like. The ether-based solvent may be dibutyl ether, or the like, but is not limited thereto.

The solvent may include an aromatic hydrocarbon-based organic solvent. Some examples of the aromatic hydrocarbon-based organic solvent may include benzene, fluorobenzene, bromobenzene, chlorobenzene, cyclohexylbenzene, isopropylbenzene, n-butylbenzene, octylbenzene, toluene, xylene, mesitylene, and the like, and this solvent may be used alone or in combination.

A first electrode film additive, which may be 3-(4-cyano-5-(4-nitrophenyl)-1H-1,2,3-triazol-1-yl)propyl 4-methylbenzenesulfonate (hereinafter referred to as “CN-15”), represented by the following [Formula 1], may be used as the functional additive added to an electrolyte solution.

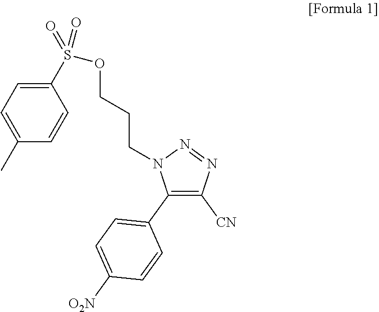 [SMILES: Cc1ccc(S(=O)(=O)OCCCn2nnc(C#N)c2-c2ccc([N+](=O)[O-])cc2)cc1]

In this case, the first electrode film additive, which may be 3-(4-cyano-5-(4-nitrophenyl)-1H-1,2,3-triazol-1-yl)propyl 4-methylbenzenesulfonate (CN-15), forms a C═O-based organic film on the surface of the positive electrode and a LiF-based SEI on the surface of the negative electrode.

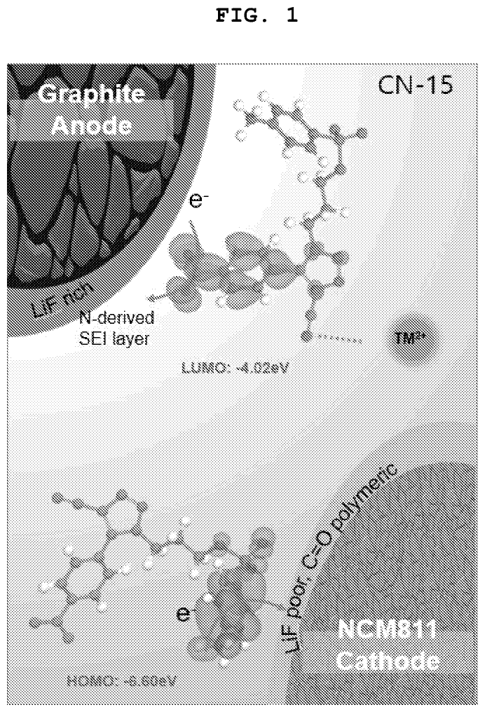

FIG. 1 is a view showing a working mechanism of a first electrode film additive, the first electrode film additive, which may be 3-(4-cyano-5-(4-nitrophenyl)-1H-1,2,3-triazol-1-yl)propyl 4-methylbenzenesulfonate (CN-15), added to the electrolyte solution, forms a LiF-based SEI on the surface of the negative electrode, thereby smoothly performing the insertion and deintercalation process of lithium ion while inhibiting the electrodeposition of lithium ions on the surface of the negative electrode.

The first electrode film additive, which may be 3-(4-cyano-5-(4-nitrophenyl)-1H-1,2,3-triazol-1-yl)propyl 4-methylbenzenesulfonate (CN-15), forms a C═O-based organic film on the surface of the positive electrode, so that the cell performance is improved.

The first electrode film additive, which may be 3-(4-cyano-5-(4-nitrophenyl)-1H-1,2,3-triazol-1-yl)propyl 4-methylbenzenesulfonate (CN-15), may be added in an amount of 0.01 to 1.0% by weight, based on the weight of the electrolyte solution. The first electrode film additive may be added in an amount of 0.05 to 0.1% by weight based on the weight of the electrolyte solution.

If the amount of the first electrode film additive to be added is less than the above presented range, it may be difficult to form a sufficient surface protective film on the surface of the positive and negative electrodes and thus a sufficient effect cannot be expected. If the amount of the first electrode film additive is more than the above presented range, the surface protective layer, SEI, may be excessively formed and the cell resistance increases, and thus the lifespan of the cell may be deteriorated.

As the functional additive, a negative-electrode film additive, serving to form a surface protective film on the negative electrode, may be further added together with the first electrode film additive. For example, the negative-electrode film additive may be a vinylene carbonate (hereinafter referred to as “VC”).

In this case, the VC used as the negative-electrode film additive may be added in an amount of 0.5 to 2.0% by weight based on the weight of the electrolyte solution. The negative-electrode film additive may be added in an amount of 1.0% by weight.

If the amount of the negative-electrode film additive to be added is less than the above presented amount(s), there may be a problem in that the long-term lifespan of the cell is deteriorated, and if the amount of the negative-electrode film additive is more than the above presented amount(s), there may be problems in that the cell resistance may increase due to the excessive formation of the surface protective layer, resulting in reduced battery output.

As the functional additive, a second electrode film additive serving to form a surface protective film on the positive and negative electrodes may be further added together with the first electrode film additive and the negative-electrode film additive. For example, lithium difluorophosphate (hereinafter, referred to as “LiPO₂F₂”) may be used as the electrode film additive.

In this case, LiPO₂F₂ used as the second electrode film additive may be added in an amount of 0.5 to 2.0% by weight based on the weight of the electrolyte solution. The second electrode film additive may be added in an amount of 1.0% by weight.

If the amount of the second electrode film additive to be added is less than the above presented amount(s), there may be a problem in that the long-term lifespan of the cell is deteriorated, and if the amount of the second electrode film additive is more than the above presented amount(s), there may be problems in that the cell resistance may increase due to the excessive formation of the surface protective layer, resulting in reduced battery output.

The lithium secondary battery according to the present disclosure may include a positive electrode, a negative electrode, and a separator, in addition to the above-described electrolyte solution.

The positive electrode may include an NCM-based positive-electrode active material containing Ni, Co, and Mn. In an example, the positive-electrode active material included in the positive electrode may include an NCM-based positive-electrode active material containing Ni in an amount of 60% by weight or more.

The negative electrode may include one or more selected from a carbon (C)-based negative-electrode active material and a silicon (Si)-based negative-electrode active material.

The carbon (C)-based negative-electrode active material may include at least one material selected from the group consisting of artificial graphite, natural graphite, graphitized carbon fiber, graphitized mesocarbon microbeads, fullerene, and amorphous carbon.

The silicon (Si)-based negative active material may include silicon oxide, silicon particles, and silicon alloy particles.

Artificial graphite or natural graphite may be used as the negative-electrode active material.

The positive electrode and the negative electrode may be produced by mixing each of active materials with a conductive material, a binder, and a solvent to prepare an electrode slurry, and directly coating a current collector with the electrode slurry, followed by drying. In this case, aluminum (Al) may be used as the current collector, but aspects of the present disclosure are not limited thereto. Since an electrode production method is known, further description thereof will be omitted.

The binder may serve to promote adhesion between particles of each active material or adhesion thereof to the current collector. For example, the binder may be polyvinyl alcohol, carboxymethyl cellulose, hydroxypropyl cellulose, diacetyl cellulose, polyvinyl chloride, carboxylated polyvinylchloride, polyvinylfluoride, an ethylene-oxide-containing polymer, polyvinylpyrrolidone, polyurethane, polytetrafluoroethylene, polyvinylidene fluoride, polyethylene, polypropylene, styrene butadiene rubber, acrylated styrene butadiene rubber, an epoxy resin, nylon, or the like, but aspects of the present disclosure are not limited thereto.

The conductive material may be used to impart conductivity to the electrode, and any conductive material can be used, as long as it is an electrically conductive material that does not cause a chemical change in the battery to be produced, and examples thereof include natural graphite, artificial graphite, carbon black, acetylene black, Ketjen black, carbon fibers, metal powders such as copper, nickel, aluminum and silver powders, metal fibers, and the like. A conductive material such as a polyphenylene derivative may be used alone or in combination.

The separator may inhibit a short circuit between the positive electrode and the negative electrode, and provide a passage for lithium ions. Such a separator may be a known separator. The separator, for example, may be polyolefin-based polymer membranes such as polypropylene, polyethylene, polyethylene/polypropylene, polyethylene/polypropylene/polyethylene, and polypropylene/polyethylene/polypropylene, or multiple membranes, microporous films, woven fabrics and nonwoven fabrics thereof. A porous polyolefin film coated with a resin having excellent stability may be used as the separator.

Hereinafter, the present disclosure will be described with reference to Examples and Comparative Examples according to the present disclosure.

### <Experiment 1> Experiment on Capacity Retention Rate at High Temperature (45° C.) According to the Type and Amount of Functional Additive

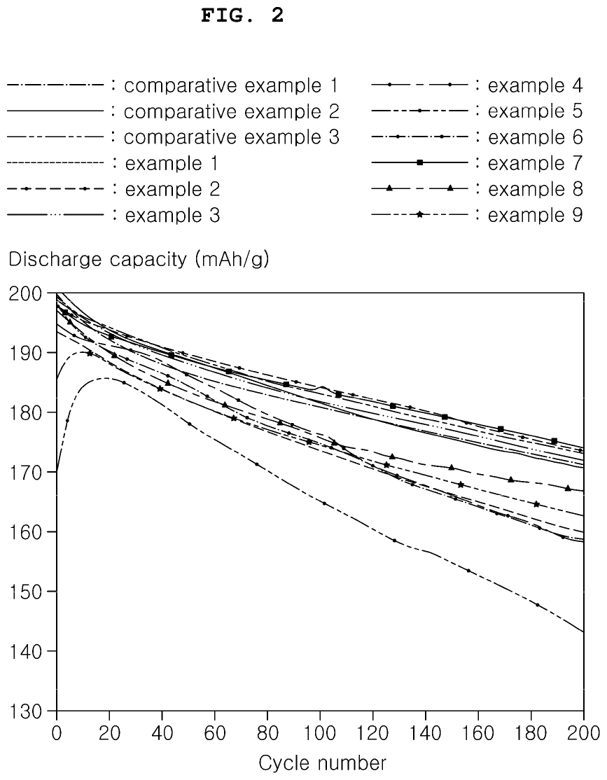

In order to determine a capacity retention rate at high temperature depending on the type and amount of a functional additive added to the electrolyte solution, a capacity retention rate characteristic at high temperature of 45° C. after 100 cycles and 200 cycles of charging and discharging was measured while the type and amount of the functional additive were changed as shown in the following Table 1, and the results were shown in Table 1 and in FIG. 2.

In this case, the experiment was carried out under the following conditions: a cut-off voltage of 2.5 to 4.2 V, a C-rate of 1 C, and temperature of 45° C. The lithium salt used to prepare the electrolyte solution was 1M LiPF₆, and the solvent used was a solvent mixture containing ethylene carbonate (EC), ethyl methyl carbonate (EMC) and diethyl carbonate (DEC) at a volume ratio of 25:45:30. A C-rate may be a charge and/or discharge rate. The C-rate may be the unit to be used to measure the speed at which a battery is fully charged or discharged. For example, charting at a C-rate of 1 C may indicate that the battery is charged from 0 to 100% in one hour.

Also, the experiment was conducted under full cell condition using the mixture of NCM811 and NCM622 as the positive electrode, and graphite as the negative electrode.

TABLE 1

| | Functional additive | | | Lifespan capacity | |
|---|---|---|---|---|---|
| | (wt %) | | | retention rate (%) | |
| Category | CN-15 | LiPO₂F₂ | VC | @ 100 cyc | @200 cyc |
| Comparative | — | — | — | 86.9 | 79.2 |
| Example 1 | | | | | |
| Comparative | — | — | 1.0 | 90.8 | 85.1 |
| Example 2 | | | | | |
| Comparative | — | 1.0 | 1.0 | 91.8 | 86.6 |
| Example 3 | | | | | |
| Example 1 | 0.01 | — | 1.0 | 89.7 | 82.8 |
| Example 2 | 0.05 | — | 1.0 | 93.5 | 88.4 |
| Example 3 | 0.1 | — | 1.0 | 92.2 | 87.1 |
| Example 4 | 0.5 | — | 1.0 | 90.1 | 81.1 |
| Example 5 | 1.0 | — | 1.0 | 91.5 | 85.1 |
| Example 6 | 0.05 | 1.0 | 1.0 | 92.3 | 87.2 |
| Example 7 | 0.1 | 1.0 | 1.0 | 93.4 | 88.5 |
| Example 8 | 0.5 | 1.0 | 1.0 | 89.4 | 84.8 |
| Example 9 | 0.1 | — | — | 91.7 | 85.4 |

As can be seen from Table 1 and FIG. 2, Example 9, in which CN-15, which was the first electrode film additive, was added alone as the functional additive, improved lifespan capacity retention rate at high temperature Comparative Example 1 in which no functional additive was added.

Examples 1 to 5 in which VC, the negative-electrode film additive, was added together with the first electrode film additive as the functional additive, improved lifespan capacity retention rate at high temperature, compared to Comparative Example 1 in which no functional additive was added.

In particular, it was confirmed that Examples 2 and 3, in which 0.05% by weight and 0.1. % by weight of the first electrode film additive were respectively added, and 1.0% by weight of VC, the negative-electrode film additive, was added as the functional additive, significantly improved lifespan capacity retention rate at high temperature compared to Comparative Example 1. Also, it was confirmed that Example 2 significantly improved capacity retention rate at high temperature compared to Comparative Example 2 in which VC, the negative-electrode film additive, was added alone without adding the first electrode film additive, and Comparative Example 3, in which the negative-electrode film additive of VC and the second electrode film additive of LiPO₂F₂ were added.

Also, it was confirmed that Examples 6 to 8, in which LiPO₂F₂, the second electrode film additive, was added along with the first electrode film additive and the negative-electrode film additive as the functional additive, significantly improved lifespan capacity retention rate at high temperature compared to Comparative Example 1, and that Examples 6 and 7 significantly improved lifespan capacity retention rate at high temperature compared to other Examples.

Accordingly, in the case that CN-15, the first electrode film additive, was added alone as the functional additive, or in the case that the negative-electrode film additive of VC and the second electrode film additive of LiPO₂F₂ were added together with the first electrode film additive as the functional additive, it was confirmed that the capacity retention rate was maintained at 89% or higher after 100 cycles of charging and discharging, and at 80% or higher even after 200 cycles of charging and discharging.

In the case that the negative-electrode film additive of VC and the second electrode film additive of LiPO₂F₂, were added together with the first electrode film additive within the amount ranges presented in the disclosure, it was confirmed that the capacity retention rate was maintained at 92% or more after 100 cycles of charging and discharging and at 87% or more even after 200 cycles of charging and discharging.

### <Experiment 2> Experiment on Output Performance at Room Temperature (25° C.) According to the Type and Amount of Functional Additive

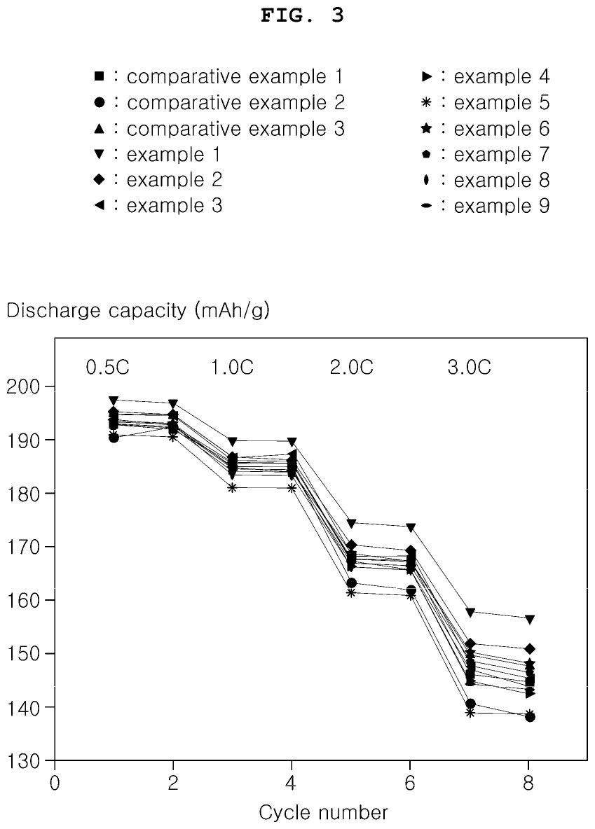

In order to determine the output performance characteristics at room temperature depending on the type and amount of functional additive added to the electrolyte solution, the output performance at room temperature of 25° C. was measured while the type and amount of the functional additive were changed as shown in the following Table 2, and the results were shown in Table 2 and in FIG. 3.

In this case, the experiment was carried out under the following conditions: a cut-off voltage of 2.5 to 4.2 V, a C-rate: charged at 0.5 C, 1.0 C, 2.0 C, 3.0 C/discharged at 0.5 C, and a temperature of 25° C. The lithium salts used to prepare the electrolyte solution were 0.5 M LiPF₆ and 0.5M LiFSI, and the solvent used was a solvent mixture containing ethylene carbonate (EC), ethyl methyl carbonate (EMC) and diethyl carbonate (DEC) at a volume ratio of 25:45:30.

Also, the experiment was conducted under full cell condition using the mixture of NCM811 and NCM622 as the positive electrode, and graphite as the negative electrode.

TABLE 2

| | Functional additive | | | | | |
|---|---|---|---|---|---|---|
| | (wt %) | | | Output performance (%) | | |
| Category | CN-15 | LiPO₂F₂ | VC | @ 1 C | @2 C | @3 C |
| Comparative | — | — | — | 96.3 | 86.8 | 75.6 |
| Example 1 | | | | | | |
| Comparative | — | — | 1.0 | 96.6 | 84.9 | 72.9 |
| Example 2 | | | | | | |
| Comparative | — | 1.0 | 1.0 | 95.6 | 86.0 | 76.3 |
| Example 3 | | | | | | |
| Example 1 | 0.01 | — | 1.0 | 96.2 | 88.3 | 79.7 |
| Example 2 | 0.05 | — | 1.0 | 95.6 | 87.1 | 77.7 |
| Example 3 | 0.1 | — | 1.0 | 96.0 | 84.5 | 75.3 |
| Example 4 | 0.5 | — | 1.0 | 95.7 | 86.3 | 74.7 |
| Example 5 | 1.0 | — | 1.0 | 95.0 | 84.5 | 72.8 |
| Example 6 | 0.05 | 1.0 | 1.0 | 95.4 | 87.0 | 77.3 |
| Example 7 | 0.1 | 1.0 | 1.0 | 96.0 | 84.5 | 75.3 |
| Example 8 | 0.5 | 1.0 | 1.0 | 95.0 | 86.0 | 75.3 |
| Example 9 | 0.1 | — | — | 96.0 | 86.3 | 73.9 |

As can be seen from Table 2 and FIG. 3, it was confirmed that Example 9, in which CN-15, which was the first electrode film additive, was added alone as the functional additive, exhibited a level of power performance at high temperature similar to that of Comparative Example 1 in which no functional additive was added.

It was confirmed that Examples 1 to 5, in which the negative-electrode film additive of VC was added together with the first electrode film additive as the functional additive exhibited similar output performance or partially improved output performance at room temperature, compared to Comparative Example 1 in which no functional additive was added.

In particular, it was confirmed that Examples 1 to 3, in which 0.01% by weight, 0.05% by weight, and 0.1% by weight of the first electrode film additive were respectively added, and 1.0% by weight of VC, the negative-electrode film additive, was added as the functional additive, overall improved output performance at room temperature compared to Comparative Example 1. Also, it was confirmed that Example 2 overall improved output performance at room temperature compared to Comparative Example 2 in which the negative-electrode film additive of VC was added alone without adding the first electrode film additive, and Comparative Example 3 in which the negative-electrode film additive of VC and the second electrode film additive of LiPO₂F₂ were added.

It was confirmed that Examples 6 to 8, in which the second electrode film additive of LiPO₂F₂ was added together with the first electrode film additive and the negative-electrode film additive, improved the output performance at room temperature compared to Comparative Examples 1 to 3 and that Examples 6 to 8 improved output performance at room temperature compared to other Example.

Therefore, as can be seen from the above experiments, it was confirmed that CN-15, which was the first electrode film additive, was added in an amount of 0.01 to 1.0% by weight, 0.05 to 0.1% by weight, based on the weight of the electrolyte solution, in terms of high temperature lifespan characteristics and room temperature output characteristics.

In particular, it was confirmed that high temperature lifespan characteristics and the room temperature output characteristics can be significantly improved when VC, the negative-electrode film additive, and LiPO₂F₂, the second electrode film additive, are added together with CN-15, the first electrode film additive, as the functional additive.

Although the present disclosure has been described with reference to the accompanying drawings and the above-described examples, aspects of the present disclosure are not limited thereto. Therefore, those skilled in the art will appreciate that various modifications, additions and substitutions are possible, without departing from the scope and spirit of the present disclosure.

What is claimed is:

1. An electrolyte solution for a lithium secondary battery, the electrolyte solution comprising:
a lithium salt;
a solvent; and
a functional additive,
wherein the functional additive comprises a first electrode film additive, which is 3-(4-cyano-5-(4-nitrophenyl)-1H-1,2,3-triazol-1-yl)propyl 4-methylbenzenesulfonate, represented by the following Formula 1:

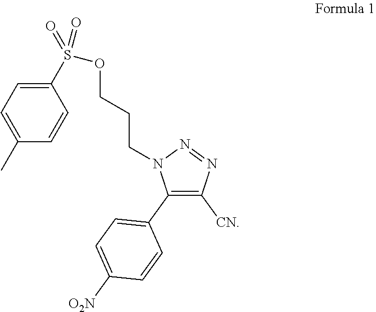 [SMILES: Cc1ccc(S(=O)(=O)OCCCn2nnc(C#N)c2-c2ccc([N+](=O)[O-])cc2)cc1]

2. The electrolyte solution of claim 1, wherein the first electrode film additive is in an amount of 0.01 to 1.0% by weight based on a weight of the electrolyte solution.

3. The electrolyte solution of claim 1, wherein the first electrode film additive is in an amount of 0.05 to 0.1% by weight based on a weight of the electrolyte solution.

4. The electrolyte solution of claim 1, wherein the functional additive further comprises a negative-electrode film additive which is vinylene carbonate (VC).

5. The electrolyte solution of claim 4, wherein the negative-electrode film additive is in an amount of 0.5 to 2.0% by weight based on a weight of the electrolyte solution.

6. The electrolyte solution of claim 1, wherein the functional additive further comprises a second electrode film additive which is lithium difluorophosphate (LiPO₂F₂).

7. The electrolyte solution of claim 6, wherein the second electrode film additive is in an amount of 0.5 to 2.0% by weight based on a weight of the electrolyte solution.

8. The electrolyte solution of claim 1, wherein the lithium salt comprises one or a mixture of two or more selected from the group consisting of LiPF₆, LiBF₄, LiClO₄, LiCl, LiBr, LiI, LiBioCl₁₀, LiCF₃SO₃, LiCF₃CO₂, LiAsF₆, LiSbF₆, LiAlCl₄, CH₃SO₃Li, CF₃SO₃Li, LiN(SO₂C₂F₅)₂, Li(CF₃SO₂)₂N, LiC₄F₉SO₃, LiB(C₆H₅)₄, LiB(C₂O₄)₂, LiPO₂F₂, Li(SO₂F)₂N, LiFSI, and (CF₃SO₂)₂NLi.

9. The electrolyte solution of claim 1, wherein the solvent comprises one or a mixture of two or more selected from the group consisting of a carbonate-based solvent, an ester-based solvent, an ether-based solvent, and a ketone-based solvent.

10. A lithium secondary battery comprising the electrolyte solution of claim 1.

11. The lithium secondary battery of claim 10, further comprising:
a positive electrode comprising a positive-electrode active material containing Ni, Co, and Mn;
a negative electrode comprising a negative-electrode active material containing one or more selected from a carbon (C)-based material or a silicon (Si)-based material; and
a separator interposed between the positive electrode and the negative electrode.

12. The lithium secondary battery of claim 11, wherein the positive electrode comprises a Ni content of 60% by weight or more.

13. The lithium secondary battery of claim 11, wherein the negative-electrode active material comprises graphite.

14. The lithium secondary battery of claim 10, wherein the lithium secondary battery has a capacity retention rate of 89% or more after 100 cycles of charging and discharging by performing one cycle of charging and discharging under a condition of 2.5 to 4.2V at a charge and/or discharge rate (C-rate) of 1 C and a temperature of 45° C.

15. The lithium secondary battery of claim 10, wherein the lithium secondary battery has a capacity retention rate of 80% or more after 200 cycles of charging and discharging by performing one cycle of charging and discharging under a condition of 2.5 to 4.2V at a charge and/or discharge rate (C-rate) of 1 C and a temperature of 45° C.
